(19) United States
(12) Patent Application Publication
(10) Pub. No.: US 2006/0008685 A1
(43) Pub. Date: Jan. 12, 2006

(54) Image forming apparatus and image forming method using the same

(75) Inventors: Kazuhiro Mizude, Souraku-gun (JP); Hiroshi Ishii, Osaka-shi (JP); Kenji Tanaka, Kitakatsuragi-gun (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/175,337

(22) Filed: Jul. 7, 2005

(30) Foreign Application Priority Data
Jul. 9, 2004 (JP) 2004-203769

(51) Int. Cl. H01M 8/06; G03G 15/20; G03G 21/00; H01M 8/04

(52) U.S. Cl. 429/17; 429/26; 429/21; 399/88

(57) ABSTRACT

The present invention provides an image forming apparatus, supplied from a commercial power supply and including a fuel cell, comprising: a fuel producing device for the fuel cell, in which the fuel producing device produces fuel for the fuel cell making use of the commercial power supply. This image forming apparatus needs little consumption of energy during periods of standby and does not need refueling even though it includes a fuel cell. Further, efficient use of commercial power supply makes it possible to shorten the time for temperature rise of the fixing unit without the necessity of increasing the wattage of the commercial power supply and avoid insufficient power supply even upon high-speed high-volume printing.

### BACKGROUND OF THE INVENTION

(1) Field of the Invention

The present invention relates to an image forming apparatus and an image forming method using it, and in particular relates to an image forming apparatus such as a copier, printer, facsimile machine and the like, which can be used with a limited, commercial power supply for small facilities, in an energy saving operation.

(2) Description of the Prior Art

Recently image forming apparatus equipped with a fuel cell using hydrogen and air have been proposed. Among these, there is a proposal of a configuration in which electric energy generated from a fuel cell is supplied to the drives and controller of the image forming apparatus and thermal energy arising from the fuel cell is used to heat the heating portion of the fixing unit (c.f. Japanese Patent Application Laid-open No. 2003-270980).

Typically, an image forming apparatus such as a copier, printer, facsimile machine and the like, includes drives for a photoreceptor, developing roller and the like, a controller for them and a thermal fixing unit for fixing the toner image onto plain paper, OHP sheets and the like. These drives, controller, fixing unit and the like should receive power supply from a commercial power supply to operate. Particularly, for heating the fixing unit its halogen heater and/or ceramic heater should be directly heated by commercial power supply; the commercial power supply is required to provide high electric power at a maximum of some thousand watt. For this reason, there have been cases that electromagnetic wave noise arises on the commercial power supply line, which often causes adverse influence on the controller and others.

Accordingly, as stated above it has been contemplated that electric energy obtained from a fuel cell is supplied to the drives and controller of the image forming apparatus so as to achieve stable operation as well as to lessen influences from noise arising on the power supply line and voltage drop, flickering and the like on the power supply line. It is also proposed that thermal energy arising at the fuel cell is supplied to the heating portion of the fixing unit (c.f. Japanese Patent Application Laid-open No. 2003-270980).

Incidentally, because of the surge of energy saving restraints, the system of the image forming apparatus itself has come to be reconsidered. For example, reduction of the consumption energy during periods of standby, which take up a high ratio of the operation of the image forming apparatus produces a large energy saving effect. For this reason, it is preferred that no power is supplied to the heating portion of the fixing unit when the image forming apparatus is unused. However, if no heating is effected to the heating portion of the fixing unit during periods of standby, it takes a long time while waiting for temperature rise of the heating portion when the apparatus is used again, resulting in poor user friendliness. On the other hand, in some recent configurations that support high-speed and high-volume continuous printing, there are cases where a safety control system is activated when insufficiency of power supply occurs at the fixing unit, and this interrupts printing halfway for the purpose of temperature recovery of the fixing unit.

In order to shorten the time for elevation in temperature of the heating portion, it is believed to be effective that the heat capacity of, not the heat roller as a heating portion of the fixing unit, but the whole fixing unit inclusive of the pressure roller should be reduced. It is also necessary to enlarge the input energy per unit time for heating the heating portion, that is, the electric power of the commercial power supply at the start. The former solution has a physical limitation. As the latter solution there has been a proposal that the time for elevating the temperature of the heating portion such as a heat roller etc., is shortened by using a power supply voltage of 200V.

In the typical offices in Japan, however the 200 V power supply is not, as yet, widespread, and a commercial power supply of 100 V with its upper current limit no higher than 15 A exists as the status quo. To deal with this situation, for the purpose of quick temperature rise of the heating portion, there has been a proposal of an image forming apparatus which employs two separate lines of commercial power supply of 100 V, 15 A, so as to increase the total power input to the heating portion of the fixing unit. However, this image forming apparatus needs to have more than one separate power outlet nearby. Whether the power supply is of a 100 V line or a 200 V line, the apparatus will be limited by power source capacity. In reference to the above conventional image forming apparatus equipped with a fuel cell, since electric energy from the fuel cell is not directly supplied to the fixing unit, it is not efficient enough to heat the fixing unit when it should be elevated in temperature. Accordingly, there has been demand for a configuration which can shorten the time for temperature rise of the heating portion in the fixing unit without the necessity of increase of usage wattage or amperage of the commercial power source to be used.

Conventionally, when a fuel cell equipped image forming apparatus is used, fuel (hydrogen, methanol, ethanol, dimethyl ether or the like) has been needed for the fuel cell, hence it has been necessary to provide a fuel storage tank in the image forming apparatus. In addition, maintenance for charging hydrogen or the like to the storage has also been needed. Further, use of a fuel cell involves formation of water or the like; these products, even though they are assumed to be discharged to the outside of the machine may increase the humidity around the image forming apparatus and degrade the environment.

### SUMMARY OF THE INVENTION

In view of the above circumstances, it is an object of the present invention to provide an image forming apparatus which needs little consumption of energy during periods of standby and uses a fuel cell but does not need refueling. It is another object of the present invention to provide an image forming apparatus which, by making efficient use of commercial power supply, can shorten the time for temperature rise of the fixing unit without the necessity of enlarging the wattage of the commercial power supply and will not cause any power insufficiency and the like even in high-speed and high-volume printing.

In order to solve the above problems, the present inventors hereof constructed an image forming apparatus including a fuel cell and a fuel producing device for forming (producing) fuel for the fuel cell, and found that, by actuating the fuel producing device while the commercial power supply is not used for the electrophotographic process, it is possible to effect quick temperature rise of the fixing unit without increase of the wattage of commercial power source and supplying little consumption energy to the fixing unit during periods of standby, that it is possible to make refueling of the fuel cell or the like, maintenance free and that it is possible to obtain a further efficient combination of commercial power supply and a fuel cell, and thus has completed the present invention.

Illustratively, the present invention is characterized by the means or configuration described by the following features (1) to (13).

(1) An image forming apparatus, supplied from a commercial power supply and including a fuel cell, comprising: a fuel producing device for producing fuel for the fuel cell, characterized in that the fuel producing device produces fuel for the fuel cell making use of the commercial power supply.

(2) The image forming apparatus defined in the above (1), wherein the energy generated from the fuel cell is supplied as an auxiliary energy source for increase of the temperature or warmup of the fixing unit of the image forming apparatus and/or for high-speed printing.

(3) The image forming apparatus defined in the above (2), wherein the fuel of the fuel cell is hydrogen and the fuel producing device is made of a water electrolysis.

(4) The image forming apparatus defined in the above (2), wherein, in addition to the electric energy generated by the fuel cell, thermal energy arising from the fuel cell is used as the auxiliary energy source by way of a heat exchanger.

(5) The image forming apparatus defined in the above (3), wherein, in addition to the electric energy generated by the fuel cell, thermal energy arising from the fuel cell is used as the auxiliary energy source by way of a heat exchanger.

(6) The image forming apparatus defined in the above (3), wherein fuel transport lines between the fuel cell and the fuel producing device are constructed by an enclosed system.

(7) The image forming apparatus defined in the above (5), wherein the fuel cell, the fuel producing device and the lines between these are constructed by an enclosed circulating system.

(8) The image forming apparatus defined in the above (6), wherein the circulating system includes a pressure detecting means.

(9) The image forming apparatus defined in the above (3), wherein water arising at the fuel cell is collected by the fuel producing device and electrolyzed.

(10) The image forming apparatus defined in any one of the above (1) to (9), wherein the fuel cell is a solid polymer fuel cell using a polymer electrolyte membrane.

(11) An image forming method using an image forming apparatus comprising: a fuel cell; and a fuel producing device for producing fuel of the fuel cell, the fuel producing device producing fuel of the fuel cell by making use of a commercial power supply, characterized in that the fuel producing device produces fuel by utilizing the commercial power supply during periods other than that for heating the fixing unit of the image forming apparatus.

(12) The image forming method defined in the above (11), wherein energy generated from the fuel cell is supplied as an auxiliary energy source for increase of the temperature or warmup of the fixing unit of the image forming apparatus and/or for high-speed printing.

(13) The image forming method defined in the above (12), wherein, in addition to the electric energy generated by the fuel cell, thermal energy arising from the fuel cell is used as the auxiliary energy source by way of a heat exchanger.

According to the image forming apparatus and the method for using it, the image forming apparatus includes a fuel cell and a fuel producing device for it, so that it is no longer necessary to periodically recharge fuel for the fuel cell, such as hydrogen, methanol, ethanol, diethyl ether or the like. This simplifies maintenance. Water vapor is generally produced as a by-product from a fuel cell; there is a fear that production of water vapor might degrade the surrounding environment of the image forming apparatus. However, since an enclosed line that integrates the fuel cell and the fuel producing device can be created, it is possible to prevent degradation of the surrounding environment of the image forming apparatus. Further, application of electric energy from the fuel cell to the fixing unit in the electrophotographic process when the fixing unit is raised in temperature, makes it possible to quickly raise the temperature of the fixing unit without increase of the wattage of commercial power supply and without wasting power consumption during periods of standby. Further, there is no fear of printing stopping during high-speed printing due to temperature reduction of the fixing unit and for its recovery of temperature at a halfway point.

Moreover, when the fuel producing device is supplied with electric power from commercial power source while the electrophotographic process is not actuated or driven, it is possible to refuel the fuel cell during periods of standby.

### BRIEF DESCRIPTION OF THE DRAWINGS

FIG. 1 is an illustrative schematic view showing an image forming apparatus according to the present invention.

FIG. 2 is a schematic view showing the relationship of lines between a fuel cell and a fuel producing device provided for an image forming apparatus according to the present invention.

FIG. 3 is a flowchart showing control timing at a fuel electric power supply controller.

### DESCRIPTION OF THE INVENTION

The embodiment of the present invention will hereinafter be described in detail.

The image forming apparatus according to the present invention and the image forming method using it should not be limited to the embodied forms shown hereinbelow.

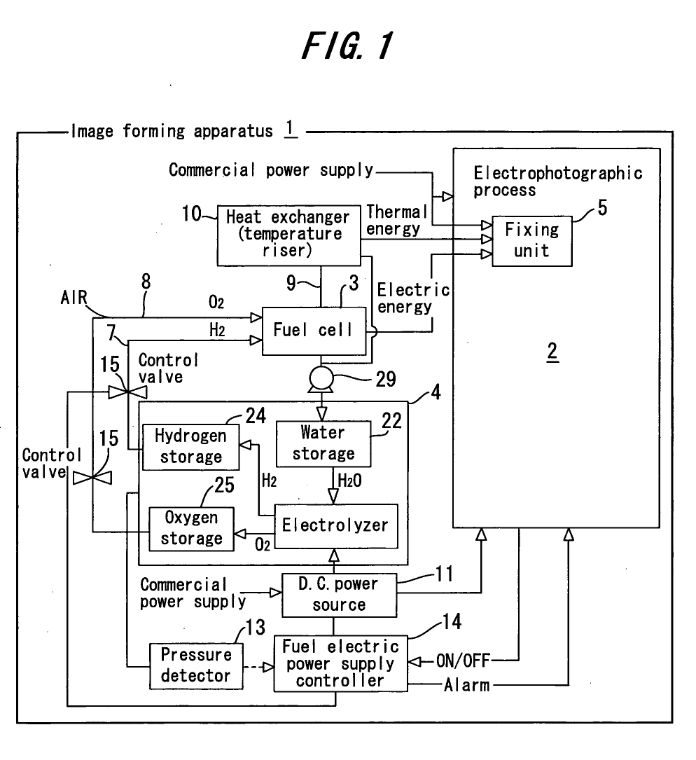

As shown in FIG. 1, an image forming apparatus 1 includes a fuel cell 3 and a fuel producing device 4 other than an electrophotographic process unit 2. Electrophotographic process unit 2 has a heat fixing unit 5 for fixing toner images to plain paper, OHP sheets and the like, further including, though unillustrated, a document reader, a photoreceptor, a developing roller, drives for these, a paper feeder, a printing portion, a discharge portion and the like. These drives, controller, fixing unit and the like are power supplied from a commercial power supply. Particularly, for heating fixing unit 5, a halogen lamp and a ceramic heater are directly heated using the commercial power supply.

Fuel cell 3 has a hydrogen transport line 7 for letting in fuel and an oxygen transport line 8 for letting in oxygen (or air), and also has a discharge line (or water collection line) 9 for discharging water vapor. Discharge line 9 may be directly connected to a water storage 22, or may be connected to water storage 22 by way of a heat exchanger 10 as in the present embodiment.

Heat exchanger 10 condenses water vapor from discharge line 9 and collects it and supplies the obtained thermal energy to heat fixing unit 5. In this case, the heat medium is raised in temperature to 180 deg. C. or higher and is fed to fixing unit 5.

Electric energy generated by fuel cell 3 is directly supplied to fixing unit 5 to heat it.

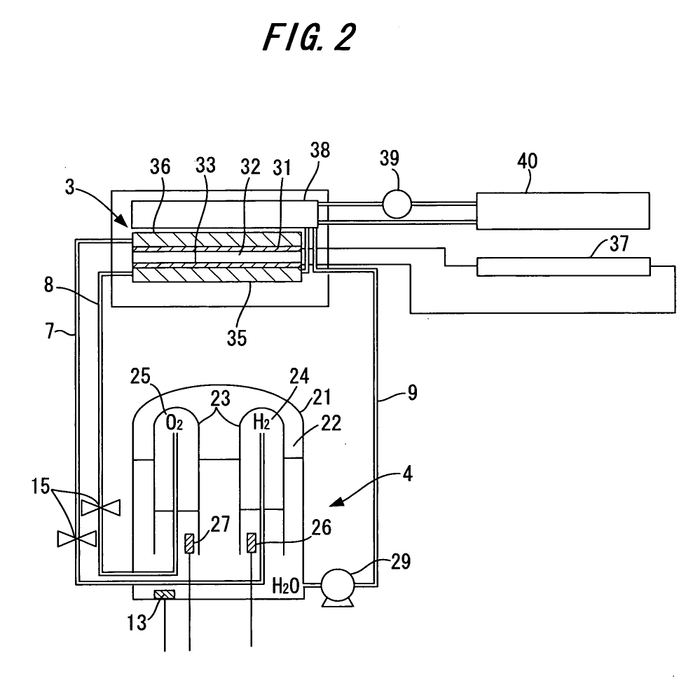

As shown in FIG. 2, fuel producing device 4 is essentially an water electrolysis, which is housed by a casing 21 including water storage 22 and hydrogen storage 24 and oxygen storage 25, defined by respective electrode caps 23. The interior of casing 21 is adapted to communicate with discharge line 9 via a circulation pump 29. Hydrogen transport line 7 and oxygen transport line 8 are inserted into casing 21; the hydrogen transport line is put in communication with hydrogen storage 24 in electrode cap 23 and oxygen line 8 is put in communication with oxygen storage 25 in the electrode cap.

In each electrode cap 23, a hydrogen producing electrode (negative electrode) 26 or an oxygen producing electrode (positive electrode) 27 is arranged, and these electrodes are connected to a d.c. power source 11 shown in FIG. 1. D.C. power source 11 is transferred from the commercial power supply and is controlled by a fuel electric power supply controller 14. A pressure sensor (or pressure detector) 13 is arranged inside casing 21; pressure sensor 13 detects the pressure inside casing 21 or the pressure of oxygen and hydrogen produced therein and transmits the detected signal to fuel electric power supply controller 14. A control valve 15 is arranged in each of the aforementioned hydrogen transport line 7 and oxygen transport line 8. These control valves 15 are controlled by fuel electric power supply controller 14.

Fuel cell 3 herein is a solid polymer fuel cell, and its anode pole 31 and cathode pole 33 are arranged opposing each other with an electrolyte membrane 32 in between. Anode pole 31 is formed of a conductive material that permits the fuel or hydrogen to spread therethrough, having a hydrogen diffusible layer 35. Cathode pole 33 is formed of a conductive material that permits the oxidizer, or oxygen or air to spread therethrough, having an oxygen diffusible layer 36. Polymer electrolyte membrane 32 is a proton conducting, or ion permeable, electrolyte membrane. A solid polymer electrolyte membrane or the like may be used; other than this, a solid electrolyte of a hetropoly acid such as molybdophosphoric acid, phosphotungstic acid or the like, being formed in a membrane structure, a matrix that is made up of an acid-resistant fine ceramic powder bounded by Teflon® and impregnated with an acid, and others may be used.

Hydrogen diffusible layer 35 is connected to hydrogen transport line 7, and oxygen diffusible layer 36 is connected to oxygen transport line 8. Water vapor is produced as a by-product from oxygen diffusible layer 36 and is collected by discharge line 9. Accordingly, fuel cell 3 and fuel producing device 4 constitute a closed circulating line including circulating pump 29, lines 7, 8 and 9.

Anode electrode 31 and cathode electrode 33 of fuel cell 3 are connected to a heat roller 37 of fixing unit 5 so that heat roller 37 can be quickly raised in temperature by electric energy from fuel cell 3. The water vapor produced at fuel cell 3 is condensed by heat exchanger 10 (including a heat absorber 38, compressor 39 and a heat discharger 40) as yielding and discharging thermal energy. The thermal energy arising at fuel cell 3 is transferred by the adjoining heat discharger 40 to heat the heat roller 37.

In the thus constructed image forming apparatus 1, as soon as image forming apparatus 1 is energized by power supply the switch of fuel electric power supply controller 14 is turned on, and fuel electric power supply controller 14 judges whether fuel cell 3 and fuel producing device 4 are ready to start warming up safely.

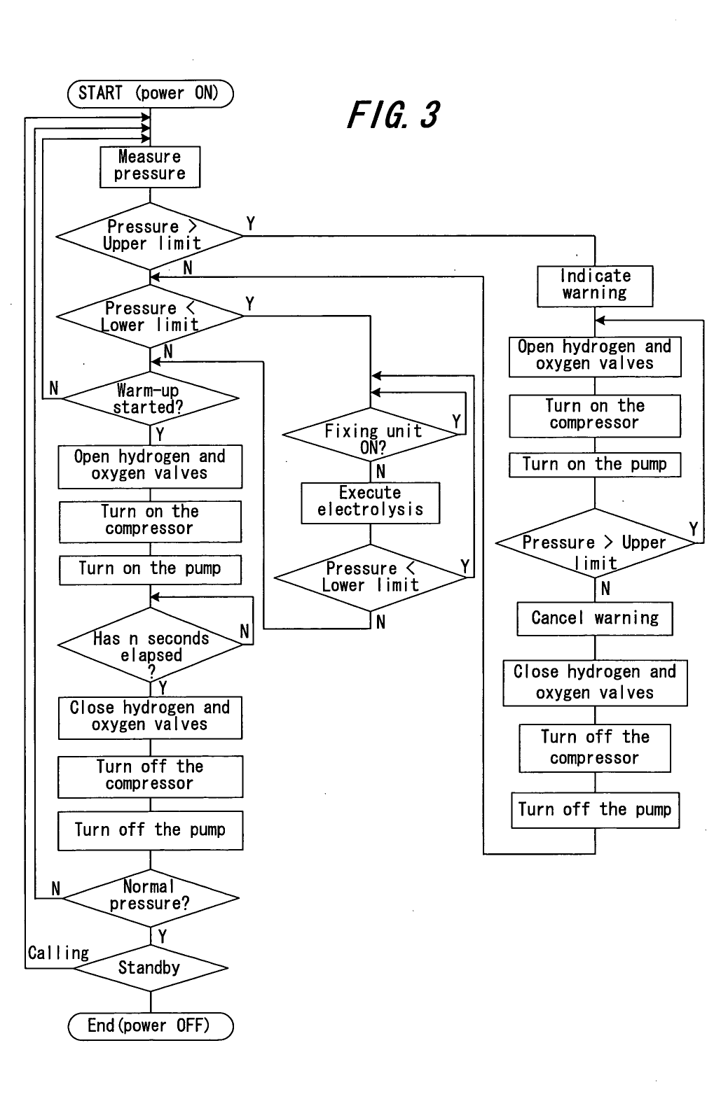

A shown in FIG. 3, upon start, pressure sensor 13 measures the pressure in hydrogen storage 24 and oxygen storage 25.

The pressure measurement data is input to fuel electric power supply controller 14, which judges whether the pressure value is greater than the predetermined upper limit.

If the judgment is affirmative, or if the pressure value exceeds the predetermined upper limit, a warning indication is given.

In order to cancel the warning, control valves 15 of hydrogen transport line 7 and oxygen transport line 8 are released and compressor 39 and circulating pump 29 are turned on. Warning indication or the like is repeated until the pressure value from pressure sensor 13 is reduced to the predetermined upper limit or lower than the upper limit. When the pressure value becomes equal to or lower than the upper limit, warning is canceled and control valves 15, compressor 39 and circulating pump 29 are turned off, then the operation returns to the main sequence.

Next, it is judged whether the pressure value is lower than the predetermined lower limit.

If the judgement is affirmative, it is judged whether fixing unit 5 is turned on or not. If the judgement is affirmative, the same loop of judgement is repeated until fixing unit 5 is off. When it is confirmed that fixing unit 5 is off and the judgement shows negative, electrolysis is started in fuel producing device 4. Electrolysis is continued by repeating this loop during the state where the pressure value is lower than the predetermined lower limit. When the pressure value becomes equal to or greater than the lower limit, the operation returns to the main sequence.

It is judged whether warm-up can be started or not; if the judgment is negative, the operation is started again from the pressure measurement.

If it is determined that warm-up can be started, control valves 15 of hydrogen transport line 7 and oxygen transport line 8 are released, and compressor 39 and circulating pump 29 are turned on so as to make fuel cell 3 active. It is judged whether the predetermined period, n seconds, has elapsed from the start of generation of electricity at fuel cell 3. After a lapse of n seconds, control valves 15 of hydrogen transport line 7 and oxygen transport line 8 are closed, and compressor 39 and circulating pump 29 are turned off so as to make fuel cell 3 inactive. Next, it is judged by pressure sensor 13 whether the pressure is normal. If the pressure is not normal, the operation returns to the start and repeats the above process until the pressure is normalized. When the pressure is normal, the apparatus is set into standby, and the operation is ended by turning off image forming apparatus 1.

In this case, after the safety of fuel producing device 4 and fuel cell 3 is verified, electric energy from both the commercial power supply and fuel cell 3 is supplied to fixing unit 5 from the start of warm-up. Heat roller 37 of fixing unit 5 is able to reach the predetermined temperature for fusing and fixing after a lapse of the predetermined period or n seconds.

When, in standby of fuel producing device 4 and fuel cell 3, a high-speed, high-volume continuous printing is started and heat roller 37 lowers in temperature, resulting in shortage of electric power for fixing unit 5, fuel electric power supply controller 14 makes a call for canceling the standby mode and the operation returns to the start position. After the condition of the warm-up start of fuel cell 3 is checked, fuel cell 3 is reactivated; in this case, thermal energy from heat exchanger 10 provided for fuel cell 3 is also used, as required, to heat the heat roller 37.

In the thus constructed image forming apparatus 1, for increase of the temperature or warmup of heat roller 37 of fixing unit 5 for the electrophotographic process, it is possible to use not only commercial power supply but also the electric energy from fuel cell 3. It is therefore possible to reduce the time for temperature rise of fixing unit 5 with a minimized wattage value of the commercial power supply. In addition, since electric energy from fuel cell 3 is also supplied to fixing unit 5 when a high-speed high-volume printing is implemented, it is possible to make stable control for heating fixing unit 5. Therefore, printing can be done without break.

In the thus constructed image forming apparatus 1, since fuel producing device 4 is provided together with fuel cell 3, it is no longer necessary to periodically refill fuel to fuel cell 3. Further, electrolysis for producing fuel to the full is effected during periods of standby. In standby, consumption of commercial power supply is inhibited to as low as possible. Execution of this electrolysis during the periods other than that for heating fixing unit 5 allows a margin for the electric power of commercial power supply, hence contributing to the operation of electrophotographic process 2 without hindrance.

Additionally, fuel cell 3 and fuel producing device 4 are constructed to form an enclosed circulating system. Limitation of an enclosed system is not a must, and it is also possible to conduct water and air other than the produced oxygen from the outside. However, formation of an enclosed circulating system made up of fuel cell 3 and fuel producing device 4 as in this embodiment makes it possible to collect resultant water vapor etc., as liquid water by way of the heat exchanger. Thus, this configuration prevents degradation of the environment inside and around the machine, i.e., increase in humidity, which would cause changes in the process conditions, image degradation, paper feed failure, paper jamming, water condensation in the optical system and the like, or environmental degradation in the office and other possible degradation. This also prevents oxygen concentration drop with no feed of air and hence can prevent discharge of unburned gas.

Further, provision of pressure sensor 13 allows for detection of abnormal increase in the pressure of the circulating system so as to stop generation of electricity by the fuel cell or electrolysis, whereby it is possible to prevent the fuel cell and fuel producing device from being accidentally broken due to excessive electrolysis, an abnormal temperature rise and others.

In the present embodiment, a solid poly fuel cell using a polymer electrolyte membrane is used for fuel cell 3, but the present invention should not be limited to this kind of fuel cell. However, use of a solid polymer fuel cell for fuel cell 3 allows for its operation at normal temperature without the necessity of preheating over 100 deg. C., which would be needed for phosphoric acid fuel cells having an operational temperature of 150 to 300 deg. C. and other fuel cells, hence the solid polymer fuel cell is effective to provide auxiliary energy to the fixing unit.

Since the image forming apparatus and image forming method according to the present invention can be used with a commercial power supply for small facilities, in an energy saving operation, and since it is possible to deal sufficiently with high-speed high-volume printing, the present invention presents high industrial applicability.

1. An image forming apparatus, supplied from a commercial power supply and including a fuel cell, comprising:
a fuel producing device for producing fuel for the fuel cell, characterized in that the fuel producing device produces fuel for the fuel cell making use of the commercial power supply.

2. The image forming apparatus according to claim 1, wherein the energy generated from the fuel cell is supplied as an auxiliary energy source for increase of the temperature of the fixing unit of the image forming apparatus and/or for high-speed printing.

3. The image forming apparatus according to claim 2, wherein the fuel of the fuel cell is hydrogen and the fuel producing device is made of a water electrolysis.

4. The image forming apparatus according to claim 2, wherein, in addition to the electric energy generated by the fuel cell, thermal energy arising from the fuel cell is used as the auxiliary energy source by way of a heat exchanger.

5. The image forming apparatus according to claim 3, wherein, in addition to the electric energy generated by the fuel cell, thermal energy arising from the fuel cell is used as the auxiliary energy source by way of a heat exchanger.

6. The image forming apparatus according to claim 3, wherein fuel transport lines between the fuel cell and the fuel producing device are constructed by an enclosed system.

7. The image forming apparatus according to claim 5, wherein the fuel cell, the fuel producing device and the lines between these are constructed by an enclosed circulating system.

8. The image forming apparatus according to claim 6, wherein the circulating system includes a pressure detecting means.

9. The image forming apparatus according to claim 3, wherein water arising at the fuel cell is collected by the fuel producing device and electrolyzed.

10. The image forming apparatus according to claim 1, wherein the fuel cell is a solid polymer fuel cell using a polymer electrolyte membrane.

11. An image forming method using an image forming apparatus comprising: a fuel cell; and a fuel producing device for producing fuel of the fuel cell, the fuel producing device producing fuel of the fuel cell by making use of a commercial power supply, characterized in that the fuel producing device produces fuel by utilizing the commercial power supply during periods other than that for heating the fixing unit of the image forming apparatus.

12. The image forming method according to claim 11, wherein energy generated from the fuel cell is supplied as an auxiliary energy source for increase of the temperature of the fixing unit of the image forming apparatus and/or for high-speed printing.

13. The image forming method according to claim 12, wherein, in addition to the electric energy generated by the fuel cell, thermal energy arising from the fuel cell is used as the auxiliary energy source by way of a heat exchanger.
